(19) United States
(12) Patent Application Publication
(10) Pub. No.: US 2011/0084154 A1
(43) Pub. Date: Apr. 14, 2011

(54) MODULAR SCREEN AND GRINDER ASSEMBLY

(75) Inventor: Michael D. Amburgey, London, OH (US)

(73) Assignee: MOYNO, INC., Springfield, OH (US)

(21) Appl. No.: 12/901,137

(22) Filed: Oct. 8, 2010

Related U.S. Application Data
(60) Provisional application No. 61/249,674, filed on Oct. 8, 2009.

(51) Int. Cl. B02C 23/18; B02C 23/08; B02C 18/18

(52) U.S. Cl. 241/15; 241/46.02; 241/81; 241/220; 241/24.1

(57) ABSTRACT

A screen and grinder assembly including a frame, a grinder unit removably coupled to the frame, and a screen unit coupled to the frame. The screen unit is configured to divert solids suspended in a liquid stream to the grinder unit for grinding thereby.

This application claims priority to U.S. Provisional Application Ser. No. 61/249,674, entitled MODULAR SCREEN AND GRINDER ASSEMBLY, filed on Oct. 8, 2009, the entire contents of which are hereby incorporated by reference.

The present invention is directed to a screen and grinder assembly, and more particularly, to a screen and grinder assembly wherein the grinder unit is removably mounted to the assembly.

### BACKGROUND

Screen and grinder assemblies can be positioned in a liquid stream that is to be processed, such as a stream of waste water. The assembly may be configured to reduce the size of solids suspended in the liquid stream, such as by grinding or shearing the solids, to facilitate further processing of the stream. The screen and grinder assembly is often of a rugged, sturdy and rigid construction to ensure that the assembly can operate over a range of adverse conditions and resist fluid pressure of the stream. Accordingly, the rugged nature of the assembly can make it difficult and expensive to access the assembly for repair and replacement. Some systems require the entire assembly to be removed for maintenance, repair or replacement.

### SUMMARY

In one embodiment the invention is a modular screen and grinder assembly in which the grinder unit is removably mounted such that grinder can be individually accessed for maintenance, repair and/or replacement. More particularly, in one embodiment the invention is a screen and grinder assembly including a frame, a grinder unit removably coupled to the frame, and a screen unit coupled to the frame. The screen unit is configured to divert solids suspended in a liquid stream to the grinder unit for grinding thereby.

### BRIEF DESCRIPTION OF DRAWINGS

FIG. 1 is a front perspective view of one embodiment of the assembly of the present invention;

FIG. 2 is a front view of the assembly of FIG. 1;

FIG. 3 is a cross section of the assembly of FIG. 1, taken along line 3-3 of FIG. 8, with the screen unit motor removed;

FIG. 4 is a front view of the assembly of FIG. 1, with the screen unit motor and reduction unit removed, and the grinder unit partially withdrawn;

FIG. 5 is a cross section of the assembly of FIG. 4 (taken along the line 3-3 of FIG. 8);

FIG. 6 is a detail view of the area indicated in FIG. 5;

FIG. 7 is a front perspective view of the assembly of FIG. 1, with the grinder unit removed;

FIG. 8 is a top view of the assembly of FIG. 1;

FIG. 9 is a top cross section taken along line 9-9 of FIG. 2;

FIG. 10 is a side cross section of the assembly of FIG. 1, with the screen unit motor removed;

FIG. 11 is a detail view of the area indicated in FIG. 10; and

FIG. 12 is a detail view of the area indicated in FIG. 10.

### DETAILED DESCRIPTION

### 1. Overview

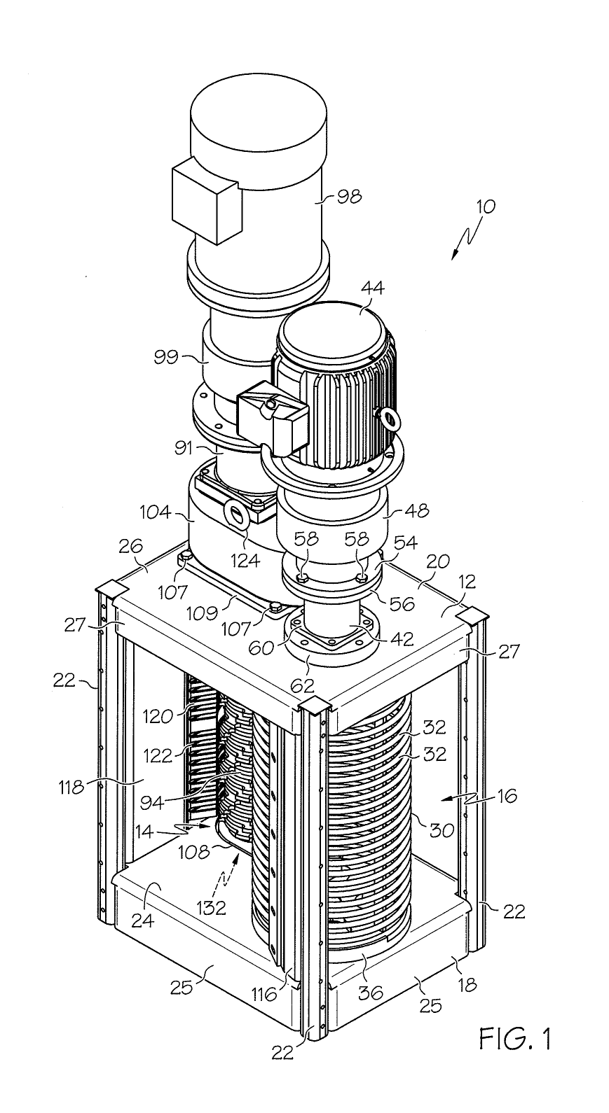

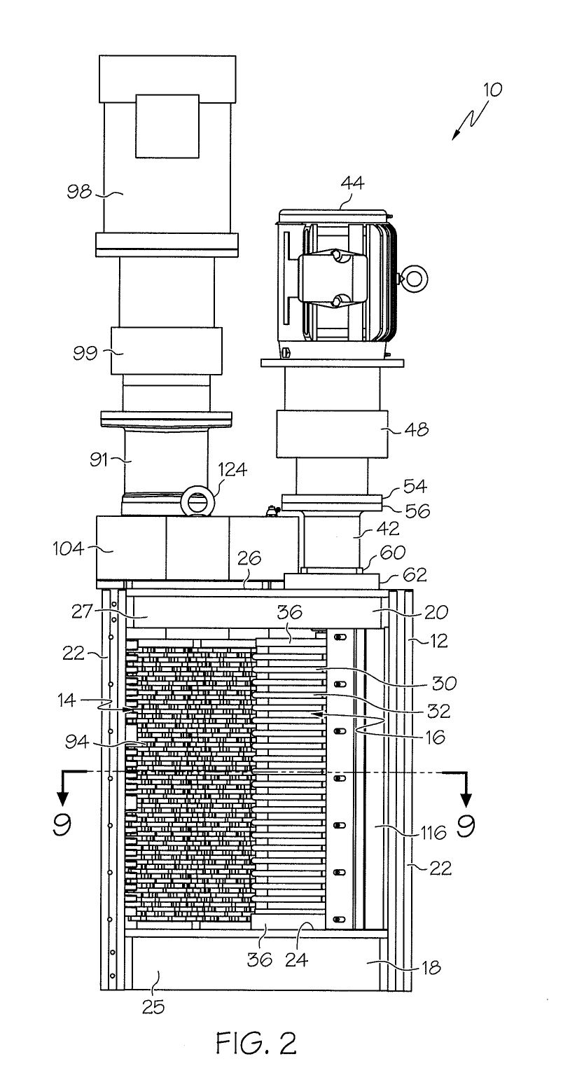

With reference to FIGS. 1-3, in one embodiment the screen and grinder assembly 10 includes a casing or frame 12, a grinder unit 14 and a screen unit/diverter unit 16. In the illustrated embodiment, the casing 12 is formed as a generally rectangular prism including a bottom cover 18, a top cover 20, and a set of four generally vertically-extending posts 22 positioned at the corners of the covers 18, 20 and extending therebetween. The bottom cover 18 may include a generally flat upper surface 24 and a generally vertically oriented flange 25 extending downwardly and around the upper surface 24. Similarly, the top cover 20 may include a generally flat upper surface 26 and a generally vertically oriented flange 27 extending downwardly and around the upper surface 26. The screen unit 16 and grinder unit 14 (or at least the fluid-processing parts thereof) may each be generally positioned in the casing 12 between the covers 18, 20 and the posts 22.

### 2. Screen Unit

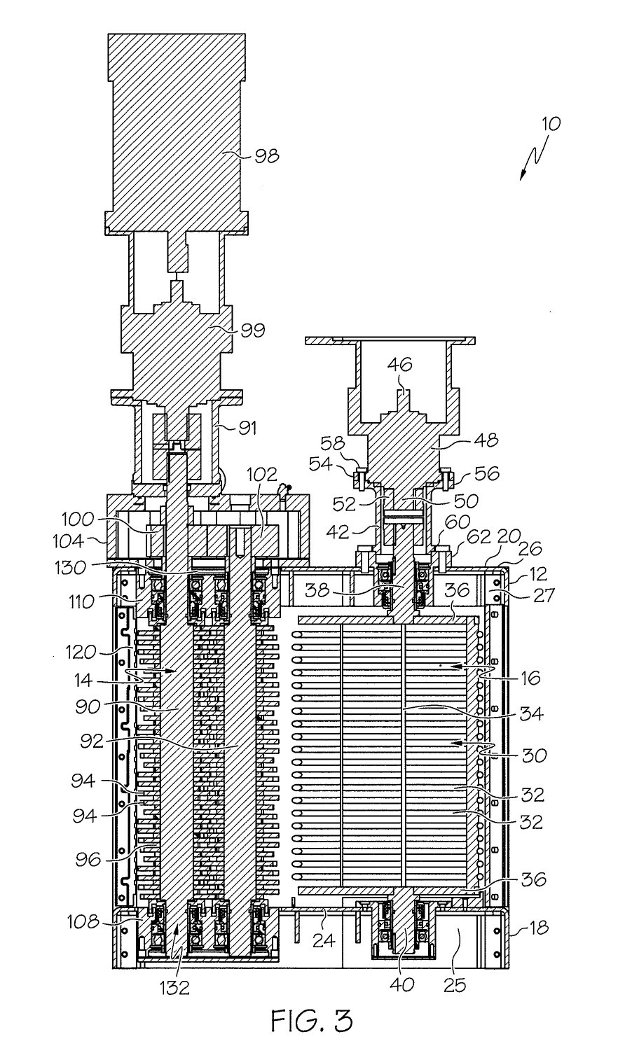

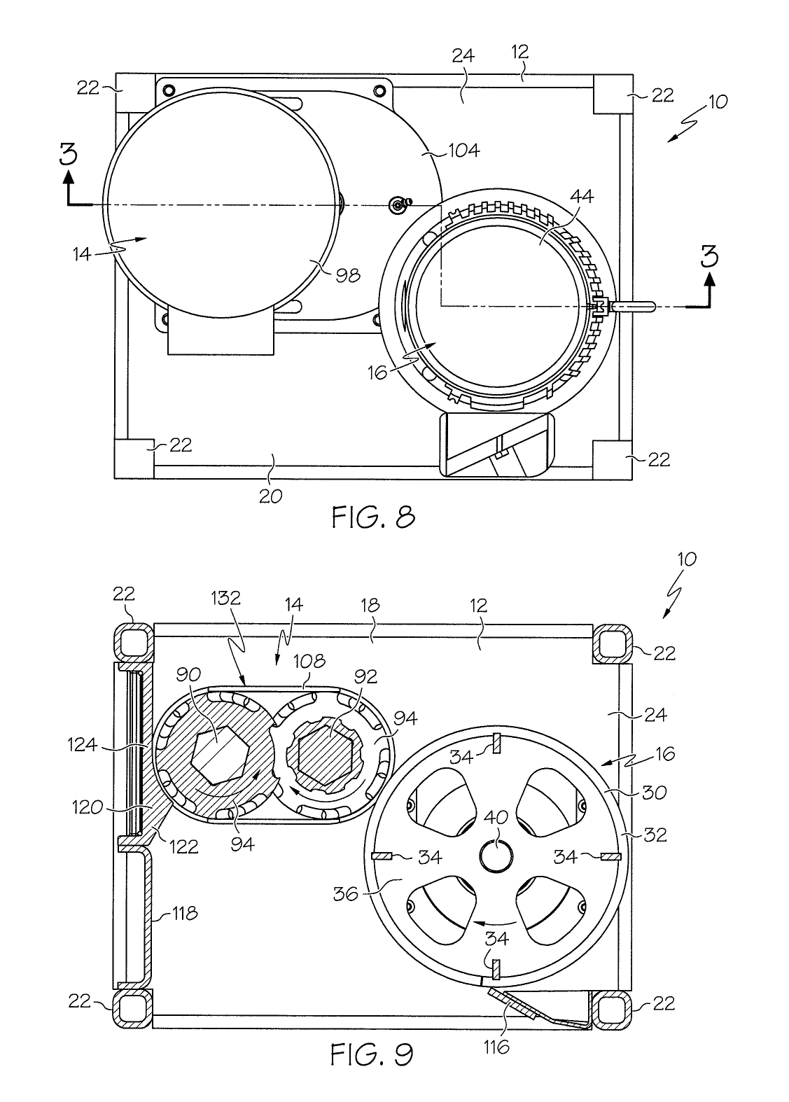

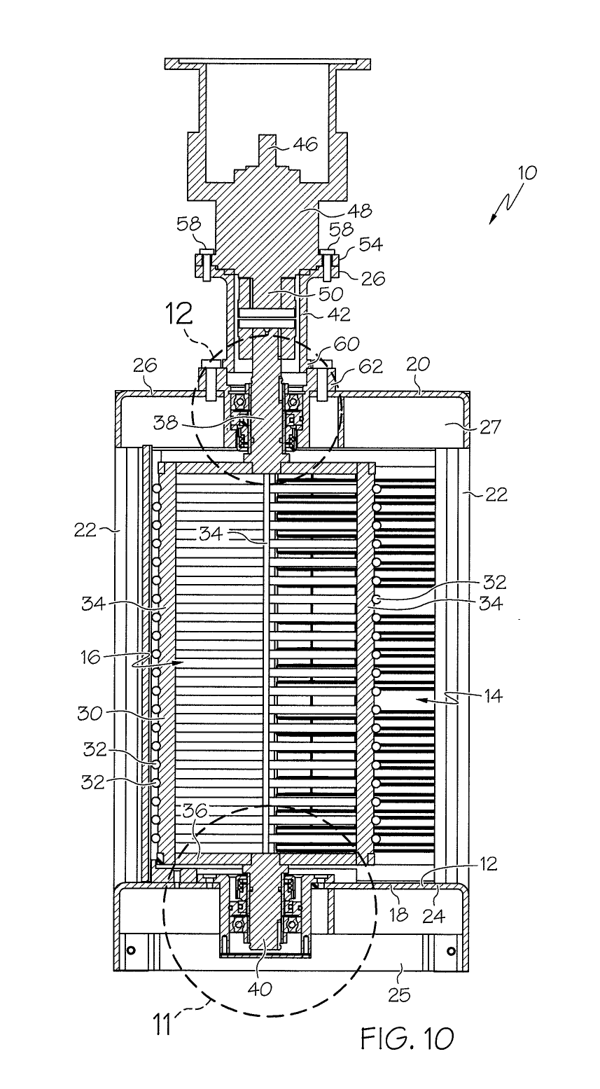

In the illustrated embodiment, the screen unit 16 includes a rotatable cylindrical drum screen 30 positioned adjacent to the grinder unit 14. In particular, the illustrated drum screen 30 includes a central axis and a plurality of rings 32 axially spaced along the central axis. The drum screen 30 includes a plurality of vertical risers 34 (see FIG. 9) positioned in the rings 32 and coupled thereto to lend stiffness and rigidity to the drum screen 30. The drum screen 30 may include an end surface 36 (see FIGS. 3 and 9) at the top and bottom ends thereof, each of which is rotationally coupled to an associated upper 38 or lower 40 shaft. The upper end of the upper shaft 38 protrudes upwardly through the top cover 20 and is enclosed within an upper shaft housing 42 (FIG. 3) to protect the upper end of the upper shaft 38.

The screen unit 16 includes a screen unit motor 44 having an output shaft that is rotationally coupled to an input shaft 46 of a reduction unit 48. The reduction unit 48, in turn, has an output shaft 50 that is rotationally coupled to the upper shaft 38 of the drum screen 30. In this manner the screen unit motor 44 is rotationally coupled to the upper shaft 38/drum screen 30 via the reduction unit 48 to drive the drum screen 30 in rotation about its central axis at the desired speed. The output shaft of the screen unit motor 44 and the input shaft 46 of the reduction unit 48, and the output shaft 50 of the reduction unit 48 and the upper shaft 38 can be rotatably coupled by any of a wide variety of rotational couplings. For example, output shaft 50 of the reduction unit 48 may carry a key 52 (FIGS. 3-5) that is received in a keyway of the upper shaft 38.

A lower end of the reduction unit 48 has radially outwardly extending flange 54, and an upper end of the upper shaft housing 42 also has an outwardly extending flange 56. A set of fasteners 58 are positioned around the periphery of the aligned flanges 54, 56, and extend through openings of the aligned flanges 54, 56, to couple the screen unit motor 44 and reduction unit 48 to the casing 12/upper shaft housing 42.

A lower end of the upper shaft housing 42 has an outwardly extending flange 60 which engages an annular surface 62 of the top cover 20. In this manner, the entire weight of the screen unit 16, including the motor 44, reduction unit 48, drum screen 30, bearing assemblies 64, seal assemblies 66 (described below), etc. is carried at the interface of the upper shaft housing 42 and the top cover 20 such that the that the screen unit 16 is essentially suspended from above the drum screen 30. This suspension of the screen unit 16 allows relatively free rotation of the drum screen 30, ensures that the drum screen 30 is properly oriented relative to the grinder unit 14 and the casing 12, and enables easier installation and removal of the drum screen 30/screen unit 16, as will be described in greater detail below. All of the weight of the screen unit 16, or substantially all of its weight, or at least 50% of its weight may be carried at the interface to provide the advantages described above.

### 3. Seal and Bearing Assembly

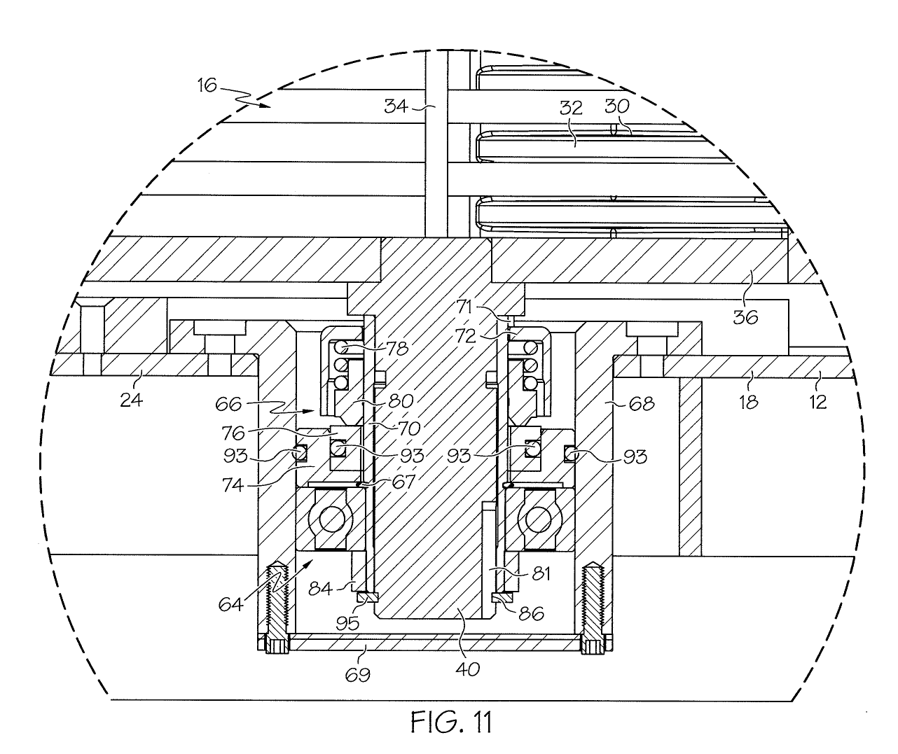

As best shown in FIG. 11, the lower shaft 40 of the drum screen 30 may be received in a bearing assembly 64 and a seal assembly 66. In particular, an opening or recessed well 68 may be formed in the bottom cover 18 which receives the bearing assembly 64 and the seal assembly 66 therein. The well 68 may include a removable cover 69 to provide access to the bearing assembly 66 and seal assembly 66. The seal assembly 66 includes a central sleeve 70 which receives the shaft 40 therein and is rotationally coupled thereto. In particular, the sleeve 70 may include a plurality of radially outwardly extending flanges 71 carried thereon which engage a corresponding surface (not shown) on the shaft 40 to rotationally couple the sleeve 70 to the shaft 40. The shaft 40 may also include an axially-extending keyway 81 at its distal end which receives a key therein (not shown) to further rotationally couple the shaft 40 to the sleeve 70. A spring cover, mechanical seal or shroud 72 is carried on or coupled to one end of the sleeve 70. The cover 72 engages the flanges 71 such that the flanges 71 maintain the axial positioning of the cover 72.

The seal assembly 66 includes a retaining component or seal insert 74 positioned on the sleeve 70, the retaining component 74 receiving a static race 76 therein. The seal assembly 60 further includes a spring 78 and dynamic race 80 positioned between the cover 72 and the static race 76 such that the spring 78 biases the dynamic race 80 against the static race 76 to form a seal therebetween. O rings 93 are positioned between the static race 76 and the retaining component 74, and between the retaining component 74 and the well 68, to aid in sealing the assembly 66.

The bearing assembly 64 in the form of a ball bearing or the like is positioned below the seal assembly 66 and receives the distal end of the lower shaft 40 therein/therethrough. A spacer sleeve 84 is positioned on the lower shaft 40 and engages the bearing assembly 64 to retain the bearing assembly 64 in place axially along the lower shaft 40. A snap ring or retaining ring 95 is positioned below the spacer sleeve 84 and received in a groove 86 of the lower shaft 40 to keep the bearing assembly 64 in place on the lower shaft 40.

A retainer ring 67 may be mounted onto the sleeve 70. During use when the bearing assembly 64 is mounted in place, the bearing assembly 64 engages the retainer ring 67 so that the retainer ring 67 maintains the bearing assembly 64 in the proper axial position. During assembly or disassembly (i.e. when the bearing assembly 64 is removed from the sleeve 70) the seal assembly 66 may engage the retainer ring 67, as biased thereagainst by the spring 78. Thus the retainer ring 67 serves the dual purpose of retaining the bearing assembly 64 in place during dynamic operation, and retaining the seal assembly 66 in place during assembly/disassembly operations.

The bearing assembly 64 is designed to be slid on the sleeve 70 after the seal assembly 66 is mounted on the sleeve 70 such that they are not mounted together. However, even after being mounted on the shaft 38/40 or sleeve 70 the bearing assembly 64 and the seal assembly 66 remain separate and are not directly attached to one another. Thus the seal assembly 66 and bearing assembly 64 are entirely separate structures that are never pre-assembled, or joined together prior to insertion or mounting. The seal assembly 66 helps to keep the bearing assembly 64 generally fluidly isolated to protect the bearing assembly 64 from fluids and ensure proper and extended operation of the bearing assembly 64.

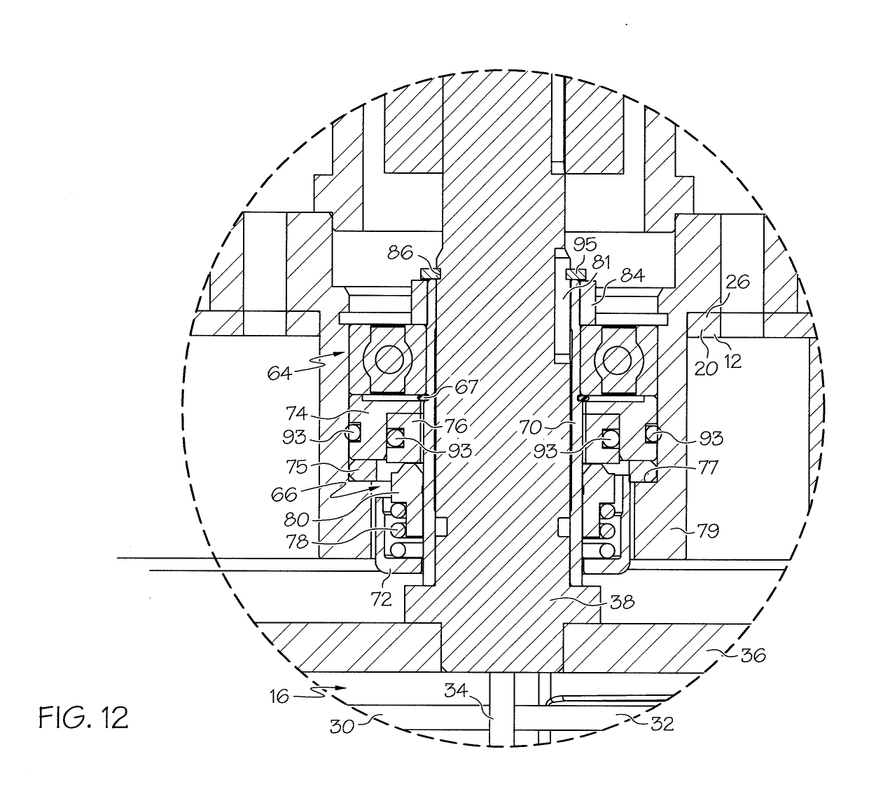

The upper shaft 38 of the drum screen 30 may be journaled using a similarly-configured seal assembly 66 and bearing assembly 64, as shown in FIG. 12. In the configuration of FIG. 12, a spacer 75 may be positioned adjacent to the seal insert 74 and a lip 77 of the seal housing 79 to support and properly locate the seal insert 74. In some cases, the spacer 75 may not be required if the axial position of the lip 77 is adjusted. The lip 77/spacer 75 may not be desired to be used with the seal arrangement shown in FIG. 11 since the seal assembly 66 and bearing assembly 64 may be desired to be adjusted axially.

### 4. Grinder Unit

The grinder unit 14 may includes a pair of parallel rotatable shafts 90, 92 (FIG. 3), each shaft 90, 92 carrying a plurality of generally disc-shaped cutter teeth 94 thereon. The teeth 94 of one shaft 90 are spaced and sized to intermesh with the teeth 94 of the other shaft 92 such that during rotation of the shafts 90, 92 the teeth 94 create shearing forces to grind, shear, comminute or macerate (collectively termed “grind” herein) suspended solids in a fluid flow. A series of spacers 96 may be mounted on the shafts 90, 92 such that a spacer 96 is positioned between adjacent teeth 94 on each shaft 90, 92 to maintain alignment of the teeth 94 and potentially to aid in grinding suspended solids.

In the illustrated embodiment, the grinder unit 14 includes a grinder unit motor 98 and a grinder reduction unit 99 operationally rotatably coupled to the motor 98 to drive the drive shaft 90. The grinder unit motor 98 is a completely separate and distinct motor/power source from the screen unit motor 44, and the motors 44, 98 are not operatively coupled together. Thus, completely different and independent drive mechanisms are utilized to drive the grinder unit 14 and the screen unit 16, which provides for simpler mechanical connections and ease of removability of the grinder unit 14, as will be described in greater detail below.

The drive shaft 90 carries a drive gear 100 thereon (FIG. 3). The drive gear 100 meshes with a driven gear 102 of the driven shaft 92, such that rotation of the drive shaft 90 causes corresponding counter-rotation of the driven shaft 92. In the illustrated embodiment, the drive shaft 90 and driven shaft 92 are driven in opposite directions (i.e., in counter rotation) toward each other, as shown by the arrows in FIG. 9. However, the shafts 90, 92 can be geared to be driven in the same direction (i.e., at differing speeds) or counter-rotated away from each other, if desired. In the illustrated embodiment, the gears 100, 102 are housed in a gear housing 104 (FIG. 3). The upper end of the drive shaft 90 extends through the gear housing 104 and is received in a drive shaft housing 91. The drive shaft housing 91 is coupled to the reduction unit 99 and the gear housing 104.

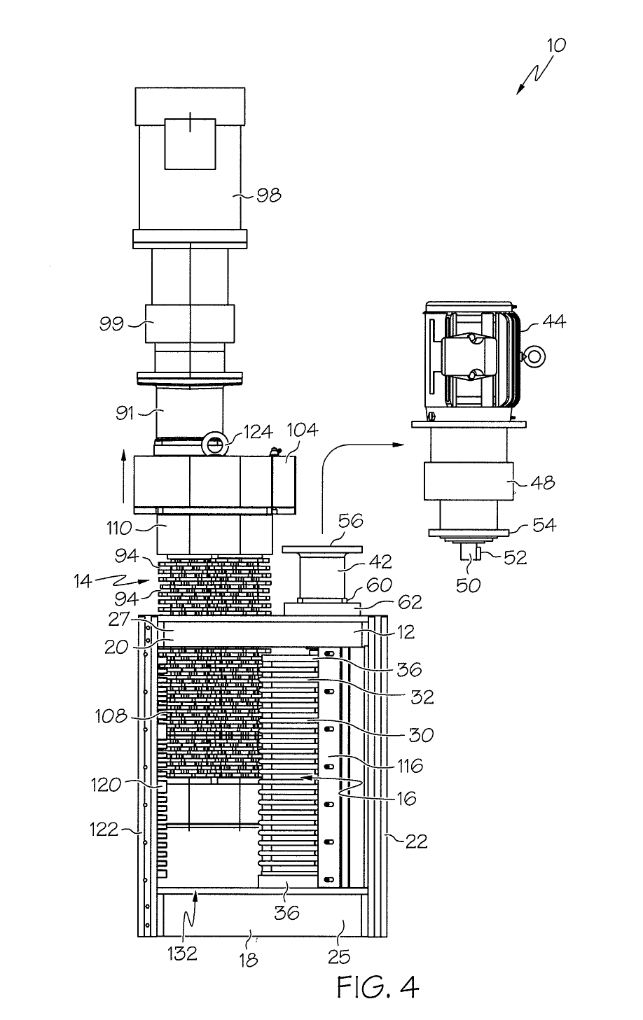

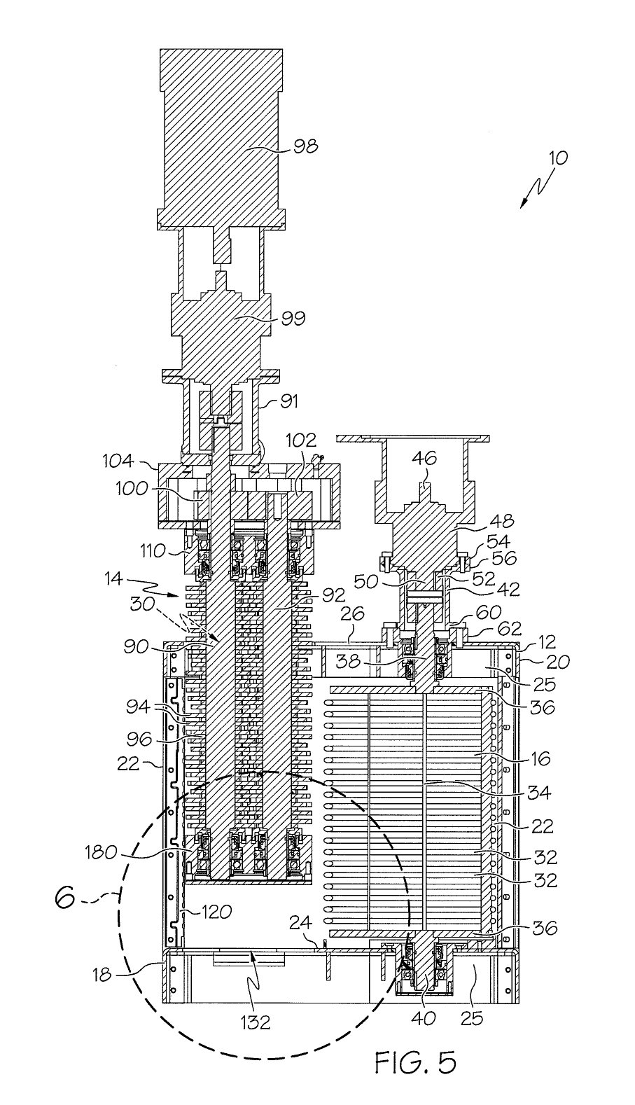

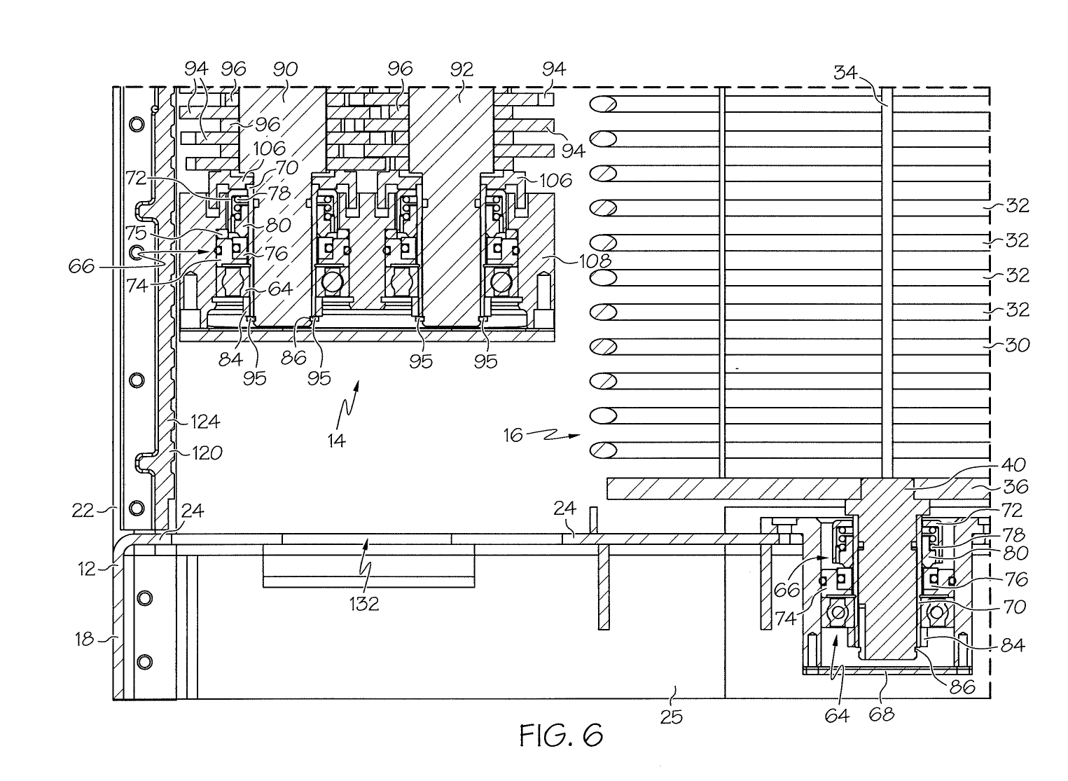

In the illustrated embodiment, the upper and lower end of each shaft 90, 92 is received in a bearing assembly 64 and seal assembly 66 (see FIG. 6) that is the same as or similar to those described above for the screen unit 16. A labyrinth seal 106 may be positioned between the teeth 94 and the seal assembly 66 to further aid in fluidly isolating the lower end of the grinder unit 14. In addition, each lower bearing assembly 64 and seal assembly 66 for the shafts 90, 92 may be received in a lower grinder casing 108 extending circumferentially around and/or below both lower bearing assemblies 66 and seal assemblies 64. Similarly, each upper bearing assembly 64 and seal assembly 66 for the shafts 90, 92 may be received in an upper grinder casing 110 (see e.g. FIGS. 4 and 5).

If desired, a set of fasteners (not shown) may extend through the top 20 and bottom covers 18, and be received in the upper 110 and lower 108 grinder casings, respectively, to couple the grinder unit 14 to the casing 12. Alternately, only fasteners associated with the top cover 20 and upper grinder casing 110 may be used since upper fasteners may be accessed more easily. Further alternately, no such fasteners may be used, and the grinder unit 14 may be held in place solely by gravity. In one embodiment the grinder unit 14 is essentially suspended from the top portion of the frame 12 such that the gear housing 104 rests on the upper surface 26, which bear all, or substantially all, of the weight of the grinder unit 14. All of the weight of the grinder unit 14, or substantially all of its weight, or at least 50% of its weight may be carried at the interface of the upper surface 26 and grinder unit 14 to provide the advantages described below.

### 5. Unit Operation

In operation, the assembly 10 is positioned in a channel through which flows a liquid stream, such as a stream of waste water that is to be processed at a sewage processing plant. The assembly 10 may be positioned in the channel such that the assembly 10 generally completely spans the channel (i.e., in a direction perpendicular to the flow of fluid). A diverter element 116 (see FIGS. 1, 2 and 9) may be positioned upstream of the drum screen 30 and provide an upstream surface arranged at an angle such that the liquid stream, and more particularly solids carried thereby, are diverted toward the drum screen 30 and prevented from passing in any gap between the drum screen 30 and the casing 12/channel wall, or to shield the half of the drum screen 30 positioned opposite the grinder unit 14. If desired, additional diverters (not shown) can be mounted on one or both sides of the casing 12 (i.e. positioned outside the casing) that extend to the channel wall to ensure that there are no gaps between the screen and grinder assembly 10 and the channel wall.

As fluid flows through the channel, the drum screen 30 is driven in rotation about its central axis such that that upstream surface of the drum screen 30 rotates toward the grinder unit 14 (i.e. in the direction shown by the arrow in FIG. 9). Liquid and solids that are sufficiently small pass through the drum screen 30 and continue downstream. Conversely, solids that are not sufficiently small to pass through the gaps in the drum screen 30 are screened/blocked by, and temporarily carried on, the screen 30. Rotation of the screen 30 carries the screened solids laterally/circumferentially toward the adjacent grinder unit 14. The pressure caused by flowing fluids, along with the changing relative angle of fluid pressure causes the screened solids to be washed off of the screen 30 (i.e. as the solids/drum screen 30 approach the nine o'clock position as viewed from the top in FIG. 9) and reintroduced into the fluid stream to flow into the grinder unit 14 for grinding into a sufficiently small size. However, various other screen units, besides drum screen units, including moving screens, diverter components and the like may be utilized in place of the drum screen unit described and shown herein.

The grinder motor 98 is operated to cause the grinder shafts 90, 92 to rotate, as outlined above. Rotation of the grinder shafts 90, 92 causes the teeth 94 carried thereon to intermesh and grind solids, thereby reducing their size in the manner described above. Thus, fluid and ground/sufficiently small solids pass through the grinder unit 14. In this manner, the grinder unit 14 and screen unit 16 cooperate to ensure only fluid and sufficiently small solids pass through the assembly 10.

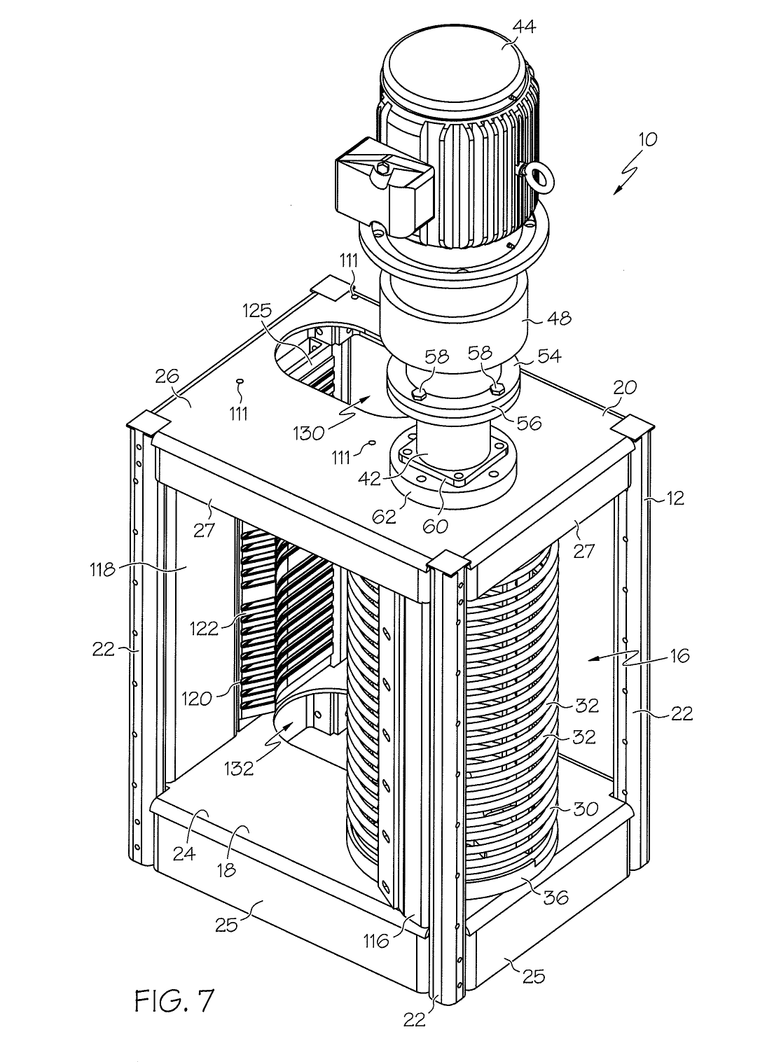

A pair of side units 118, 120 may be positioned in the casing 12 and adjacent to the grinder unit 14, extending between the top 20 and bottom covers 18 (see FIGS. 7 and 9). The upstream side unit 118 may be generally flat. The downstream side unit 120 may be positioned adjacent to the upstream side unit 118 and have a slotted, tapered upstream surface 122 which guides the stream toward the grinder unit 14 for grinding thereby, and a slotted tapered downstream surface 125 which generally conforms around the teeth 94 of the grinder unit 14, and generally extends away toward the adjacent channel wall.

### 6. Modular Components

The assembly 10 may be configured in a modular manner to allow the grinder unit 14 to be easily removed and replaced/reinstalled. In one embodiment, in order to remove the grinder unit 14, the screen unit motor 44 and reduction unit 48 are first removed, such as by removing the fasteners 58 coupling the reduction unit 48 to the upper shaft housing 42. The screen unit motor 44 and reduction unit 48 are then removed (FIG. 4) and set aside. In the illustrated embodiment, the screen unit motor 44 and reduction unit 48 are removed since those components may otherwise interfere with the removal of the grinder unit 14 (i.e. those components are positioned vertically above parts of the grinder unit 14). However, in some cases the screen unit motor 44 and reduction unit 48 may not interfere with removal of the grinder unit 14, in which case those components need not be removed first. In some other cases, the screen unit motor 44, but not the reduction unit 48, is removed prior to removing the grinder unit 14.

After the screen unit motor 44 and/or reduction unit 48 is removed (if necessary), any fasteners (if utilized) coupling grinder unit 14 to the frame 12 are then removed to decouple the grinder unit 14 from the frame 12 and enable removal of the grinder unit 14. As shown in FIG. 1, in one embodiment a set of fasteners 107 are passed through a plate 109 of the gear housing 104. Each fastener 107 (four threaded fasteners 107 in the illustrated embodiment) is received in an opening 111 formed in the top cover 20 (see FIG. 7). These fasteners 107 may be able to be removed by tools, and may number less than about ten in one embodiment, or less than about five in another embodiment, to enable the grinder unit 14 to be easily decoupled. However, rather than using threaded fasteners, the grinder unit 14 may be coupled to the frame with clamps, latches, or other manually-operated quick-attach devices. In the illustrated embodiment, all fasteners 107/component that are required to be removed to enable removal of the grinder unit 14 are positioned at the upper portion of the grinder unit 14/assembly 10, and more particularly generally above or on top of the frame 12, providing ease of access thereto. This arrangement avoids having to access lower portions of the assembly 10, which can be difficult due to constraints provided by a channel, submersion of some components, etc.

After the grinder unit 14 is decoupled from the frame 12, as shown in FIGS. 4 and 5, the grinder unit 14, including the motor 98, reduction unit 94, gear housing 104, and upper 110 and lower 108 grinder casings are then lifted vertically (i.e. along the direction of the axis of the shafts 90, 92 or the axis of the grinder unit 14 as a whole) out of the casing 12. If desired, the grinder unit motor 98 and/or reduction unit 94 may be removed prior to lifting the grinder unit 14 to reduce weight and/or improve ease of handling. The grinder unit 14 may have one or more lifting rings 124 (FIGS. 1, 2 and 4) to aid in lifting the grinder unit 14. Thus the grinder unit 14 can be removed as a single, intact unit, without requiring disassembly of the casing 12, grinder unit 14 or other components of the assembly. Moreover, in one embodiment the grinder unit 14 is essentially suspended from the top portion of the frame 12 such that the gear housing 104 rests on the upper surface 26. This arrangement enables easy removal of the grinder unit 14 as no access is required to the bottom portion of the frame 12, which may be more difficult to access.

The grinder unit 14 may need to be periodically accessed in order to repair, replace or maintain the cutting teeth 94, the seal assembly 66, bearing assembly 64, or other parts or components thereof. Thus, the modular nature of the assembly 10 allows the grinder unit 14 to be removed as desired. The removable nature of the grinder assembly 14 provides significantly improved ease of access to the grinder unit 14 for maintenance, repair, replacement or the like. More particularly, the removed grinder unit 14 can be oriented as desired (i.e., laid horizontally on a work table or surface) for such maintenance or repair.

In addition, attempts to access the grinder unit 14 when it is installed in the casing 12 and/or in the channel can be challenging due to space constraints, limited access due to the presence of the frame 12 and other component, and due to an unpleasant work environment, such as when the assembly 10 is used in a wastewater treatment plant or the like. The arrangement specified herein also allows the grinder unit 14 to be removed and/or replaced without having to drain the entire channel, thereby resulting in significant time savings. Finally, significant advantages are provided by enabling removability of the grinder unit 14 itself, as opposed to the entire assembly 10, due to the significant weight of the assembly 10. In particular, if only the grinder unit 14 is removed, a simple hoist (such as a ratchet hoist) which can be manually operated and/or easier to access and manipulate can be used, instead of a motorized crane or the like which requires greater time and expense to operate.

In order to replace or re-insert the grinder unit 14, the grinder unit 14 is lowered into place into the casing 12. In particular, the top cover 20 and bottom cover 18 may each have an opening 130, 132 formed therein, respectively (see FIG. 7) which is generally sized and shaped to closely receive and upper grinder casing 110 and lower grinder casing 108, respectively, therein/therethrough. For example, in the illustrated embodiment, each grinder casing 108, 110 and opening 130, 132 is generally oval in end view, with each opening 130, 132 being sized to closely receive a grinder casing 108, 110 therein.

The grinder unit 14 is lowered until the gear housing 104 (which is larger than the top opening 130 in the illustrated embodiment) rests on top of the top cover 20. Fasteners 107, if utilized, are secured in place, or some other coupling system may be used to couple the grinder unit 14 to the casing 12. If desired, the bottom cover 18 may have a generally oval-shape well (not shown) adjacent to the bottom opening 132 to closely receive the lower grinder casing 108 therein, and the top cover 20 may have generally oval sidewalls (not shown) adjacent to the upper opening 130 to closely receive the upper grinder casing therein along an axial extent thereof.

The grinder casings 110, 108 may define the (radially) outer-most portions of the grinder unit 14 when the grinder unit 14 is viewed axially from its end, as shown in FIG. 9 for example. In this manner the grinder unit 14 can be passed through the aligned openings 130, 132 so that the casing 12 closely receives and retains the grinder unit 14 therein. The relatively tight fit between the openings 130, 132 and grinder casings 110, 108 help to securely hold the grinder unit 14 in place and resist torque forces applied by operation of the grinder unit 14, displacement forces caused by the flow of fluid, etc.

The grinder casings 108, 110 and openings 130, 132 can have a variety of eccentric and non-circular shapes in end view, besides oval shapes, although an oval shape efficiently accommodates the two circular gears 100, 102 therein with each gear 100, 102 being positioned at end of the oval, as shown in FIG. 9. If desired, bushings or resilient material may be located in or adjacent to the upper 130 and lower 132 openings to ensure a tight fit between the casing 12 and the grinder unit 14 and reduce or minimize vibration or rattling. Moreover, the upper and lower openings 130, 132 may include or be positioned adjacent to tapered surfaces to guide the grinder unit 14 into place as it is lowered.

The fit between the casing 12/openings 130, 132 and grinder unit 14/grinder casings 110, 108 also help to maintain precise alignment between the screen unit 16 and grinder unit 14 which may be important to ensure proper functioning of the screen and grinder assembly 10. In particular, close tolerances may be required between the grinder unit 14 and the screen unit 16, and between the grinder unit 14 and the casing 12, to ensure that relatively large solids do not pass therethrough, and to ensure that solids from the screen unit 16 are properly transmitted to the grinder unit 14. Cooperation between the top 130 and bottom openings 132 and the grinder casings 110, 108 hold the grinder unit 14 in place at its top and bottom ends so that this securing arrangement does not interfere with the flow of fluid, while still securely retaining the grinder unit 14 in place in a precise manner. The openings 130, 132 also provide a securing arrangement which can be used for repeated removal/replacement of the grinder unit without degradation.

Grinder units 14 typically require significantly more maintenance, repair, and replacement than diverter units 16 due to the high-wear nature of grinder unit 14 which grind solids, as opposed to merely diverting them. Thus the arrangement disclosed herein allows the higher-maintenance unit (the grinder unit 14) to be removed and replaced. If desired, in some cases the diverter unit 16 may also be removably mounted and removable vertically along its central axis in an analogous manner to the removal of the grinder unit 14, as described herein. Alternately, the diverter unit 16 may be non-removably/permanently coupled to the frame 12 such that the diverter unit 16 cannot be removed without significant disassembly of the frame 12 or diverter unit 16 other components.

It should be understood that the assembly 10 can have any of a wide variety of shapes and configurations besides that specifically shown herein. For example, rather than positioning the screen unit 16 on the right-hand side of the grinder unit 14 (as viewed from upstream), the screen unit 16 may be positioned on the left-hand side of the grinder unit 14. In addition, multiple screen units 16 may be utilized, such as two screen units 16 with a grinder unit 14 positioned therebetween. In each case the grinder unit 14 and screen units 16 may be configured as described herein, enabling easy removal and proper alignment of the grinder units 14.

Although the invention is shown and described with respect to certain embodiments, it should be clear that modifications will occur to those skilled in the art upon reading and understanding the specification, and the present invention includes all such modifications.

What is claimed is:

1. A screen and grinder assembly comprising:
a frame;
a grinder unit removably coupled to said frame; and
a screen unit coupled to said frame and configured to divert solids suspended in a liquid stream to said grinder unit for grinding thereby.

2. The assembly of claim 1 wherein said grinder unit includes at least one grinding component rotatable about an axis, and wherein said grinder unit is removable from said frame in a direction along said axis.

3. The assembly of claim 1 wherein said grinder unit is removable by lifting said grinder unit vertically out of said frame.

4. The assembly of claim 1 wherein said grinder unit is removably coupled to said frame by a set of removable or releasable fasteners.

5. The assembly of claim 4 wherein all of said removable or releasable fasteners are positioned on an upper portion of said assembly.

6. The assembly of claim 1 wherein said grinder unit is removably coupled to said frame by about five or less removable or releasable fasteners which, when removed or released, enable said grinder unit to be removed from said frame as a single unit.

7. The assembly of claim 1 wherein said grinder unit includes a pair of parallel, spaced-apart rotatable shafts, each shaft carrying a plurality of axially-spaced cutter elements thereon which interleave with said cutter elements of the other shaft to grind suspended solids carried in a liquid stream passed therethrough.

8. The assembly of claim 1 wherein said screen unit includes a rotatable drum screen configured to allow fluids to pass therethrough and configured to rotate relative to said frame to divert sufficiently large solids suspended in said liquid stream toward said grinder unit.

9. The assembly of claim 1 wherein said frame is configured to closely receive at least part of said grinder unit therein.

10. The assembly of claim 1 wherein a portion of said grinder unit received in said frame has an outer shape when viewed from an axial direction thereof, and wherein said frame has an opening generally corresponding to said outer shape and configured to closely receive therein a portion of said grinder unit having said outer shape.

11. The assembly of claim 10 wherein said portion of said grinder having said outer shape is positioned at or adjacent to an axial end thereof, and wherein said opening is positioned at or adjacent to an upper end of said frame.

12. The assembly of claim 10 wherein said outer shape and said opening are non-circular.

13. The assembly of claim 10 wherein said frame has a supplemental opening generally corresponding to said outer shape, and wherein said opening closely receives an upper portion of said grinder unit therein and said supplemental opening closely receives a lower portion of said grinder unit therein, and wherein said opening, said supplemental opening, said upper portion and said lower portion are all generally oval-shaped.

14. The assembly of claim 1 wherein said grinder unit is coupled to said frame in a suspended manner such that the majority of the weight of said grinder unit is supported at an upper portion of said frame.

15. The assembly of claim 1 further comprising a grinder unit motor operatively coupled to said grinder unit and a screen unit motor operatively coupled to said screen unit, wherein said grinder unit motor and said screen unit motor are separate and distinct power sources.

16. The assembly of claim 1 further comprising a screen unit motor operatively coupled to said screen unit, and wherein said screen unit motor is removably coupled to said screen unit.

17. The assembly of claim 1 further comprising a screen unit motor operatively coupled to said screen unit, and wherein said screen unit motor is positioned such that it does not interfere with the removal of said grinder unit from said frame.

18. The assembly of claim 1 wherein said screen unit is removably coupled to said frame.

19. The assembly of claim 1 wherein said screen unit is permanently and non-removably coupled to said frame.

20. The assembly of claim 1 wherein said assembly is positioned in a fluid-filled channel, said screen unit is being operated to divert sufficiently large solids suspended in a liquid stream toward said grinder unit, and wherein said grinder unit is being operated to grind solids suspended in said liquid stream.

21. A screen and grinder assembly comprising:
a frame;
a grinder unit configured to be removably coupled to said frame; and
a screen unit coupled to said frame and configured to divert solids suspended in a liquid stream to said grinder unit for grinding thereby when said grinder unit is removably coupled to said frame.

22. The assembly of claim 21 wherein said grinder unit is removably coupled to said frame.

23. A method for operating a screen and grinder assembly comprising:
providing a screen and grinder assembly including a frame, a grinder unit removably coupled to said frame, and a screen unit coupled to said frame;
introducing, to said assembly, a liquid stream carrying suspended solids;
operating said screen unit to divert sufficiently large suspended solids toward said grinder unit; and
operating said grinder unit to grind suspended solids.

24. The method of claim 23 further comprising the step of removing said grinder unit from said frame.
